(19) United States
(12) Patent Application Publication
(10) Pub. No.: US 2020/0265022 A1
(43) Pub. Date: Aug. 20, 2020

(54) Intent Signaling with Collaborators

(71) Applicant: Microsoft Technology Licensing, LLC, Redmond, WA (US)

(72) Inventors: Erez Kikin Gil, Bellevue, WA (US); Seth Fox, Redmond, WA (US); Daniel P. Costenaro, Redmond, WA (US); Aleta E.C. Bashaw, Duvall, WA (US); Keri D. Talbot, Sammamish, WA (US)

(21) Appl. No.: 16/278,585

(22) Filed: Feb. 18, 2019

(51) Int. Cl. G06F 16/176; G06Q 10/10; G06F 16/18; G06F 17/24

(52) U.S. Cl. CPC G06F 16/1774; G06F 17/241; G06F 16/1873; G06Q 10/101

(57) ABSTRACT

A collaborator creates a personal work space within a document or project space and signals intent to other collaborators regarding the activity being performed in the personal work space. The personal work space may include a note space for the collaborator to add text signaling intent of the collaborator in modifying the document or project in the personal work space. For example, the note space may include an indication of a time when the collaborator started work in the personal work space and/or an indication that the collaborator is actively working in the personal work space or that the collaborator has completed work in the personal work space. The collaborator also may modify the viewability of the personal work space to permit the personal work space to be viewed by all collaborators, no collaborators, or one or more specified collaborators by assigning other collaborators permissions to the personal work space.

### BACKGROUND

Conventional document collaboration solutions enable multiple collaborators to simultaneously review and revise a document. Each collaborator may observe changes made by other collaborators in real-time. However, a collaborator may not always find it desirable for other collaborators to see the collaborator's changes as they are being entered. For example, a collaborator may prefer that other collaborator's not review her revisions to a portion of the document until she deems the changes ready to be viewed. In other words, it may be desirable for a collaborator to have her own private workspace within a document so that she may revise a portion of a document in private and signal to other collaborators that a section of the document is being revised. Such signaling is referred to herein as “intent signaling.”

In conventional collaboration systems, a tension exists between keeping all collaborators “in the loop” regarding ongoing revisions and the desire by individual collaborators to have some privacy to work through their ideas in their own work space before making the collaborator's proposals/changes available to other collaborators. Of course, the collaborator may block copy a portion of the document into a separate application outside of the document collaboration system, make her revisions, and then email the revisions in the body of an email or as an attachment to other collaborators in side channel communications, and insert the revised section into the original document within the document collaboration system. However, this approach is cumbersome and is not transparent collaborative behavior as this approach does not appropriately signal to other collaborators that the collaborator is working on a particular section of the document or provide any indication to other collaborators regarding what is being done to that section of the document. Moreover, conventional collaboration systems may allow other collaborators to see that a section of a document is being revised by another collaborator, such collaboration systems provide no indication as to whether the other collaborator has finished her revisions or the nature of the revisions. Such behavior may also lead to versioning problems as other collaborators may work on the same section of the document at the same time without an appreciation that other collaborators are still working on a particular section of the document.

A collaboration system has been described that addresses some of these issues by providing a collaborative authoring system that includes scratchpad functionality whereby a private or shared scratchpad is provided to one or more collaborators for sharing ideas without prolonged exchanges. Such systems also implement comments in the form of private notes, a document mode (e.g., all changes are shown to others as faded text where the reader must request access to view the text clearly) or apply a property to a paragraph or text range (e.g., mark a section as a “work in progress”). The private or shared scratchpad, etc. thus may be used to create or edit content without other collaborators seeing the changes immediately as in conventional collaboration systems. In the case of scratchpad functionality, for example, upon activation of the private working mode, a complementary user interface is presented to the collaborators sharing the scratchpad (or just a single collaborator for a private scratchpad) and is hidden from other collaborators. An indication is provided to the scratchpad collaborators indicating that they are working in a private working mode. Once the collaborator(s) has/have finished working in private mode, the collaborator(s) is/are switched to collaboration mode and the edits made in the private mode are merged into the shared content through a merge control. However, this system does not signal to those collaborators who are not working in private mode any useful information other than an indication that a particular section is being edited by one or more other collaborators.

### SUMMARY

Various details for the embodiments of the inventive subject matter are provided in the accompanying drawings and in the detailed description text below.

The following description outlines a technique that provides a simplified and unified way to signal intent to other collaborators in a document collaboration system. Intent signaling may include whether the reviewing/editing is complete or in progress, the type of work being done (reviewing, authoring, etc.), content that a collaborator is working on, etc. Conversely, intent signaling may be used to signal intent to other collaborators that a first collaborator is adding a section to the document on a particular topic and that the system should turn down the noise from other collaborators in the document and from system events (e.g., proofing) to help the collaborator stay on task. These features facilitate the effective and efficient collaboration for synchronous and asynchronous collaboration whether the collaborators are together or apart. For example, a collaborator may easily indicate to other collaborators that the portion of the document she is working on is background research in an early draft state that she prefers that others not view yet, which prevents other collaborators from becoming distracted by the ongoing work and provides the collaborator with a sense of privacy and an independent focus area for her work. A draft space is provided that is may be outside of the main document work area or in-line within the document and that can, in either case, substitute for opening other documents or applications for this workspace. Collaborators also may be invited to work in this draft space, to maintain context, to write/update status, and to fold the changes back into the document seamlessly.

In sample embodiments, the methods described herein provide system and methods for signaling intent to other collaborators in a document or project space. A personal work space is created within the document or project space for a collaborator. The personal work space includes a note space for the collaborator to add text signaling intent of the collaborator in modifying the document or project in the personal work space. The note space may include an indication of a time when the collaborator started work in the personal work space, that the collaborator is actively working in the personal work space, and/or or that the collaborator has completed work in the personal work space. The collaborator may also modify the viewability of the personal work space to permit the personal work space to be viewed by all collaborators, no collaborators, or one or more specified collaborators. For example, the collaborator may assign permissions to a chunk of content of the document for controlling the ability of other collaborators to access the personal work space to view or edit the chunk of content according to the permissions of the other collaborators. In sample embodiments, the personal work space is in a view pane within the document or project space. The personal work space may also be formed as a branch of the original document.

In further sample embodiments, a notification may be sent to other collaborators indicating that the collaborator's modifications in the document or project space have been completed. The other collaborators that are to receive the notification may be determined by tracking which collaborators have interacted with a portion of the document or project space that has been modified by the collaborator. The notification may further include an indication of a time when the collaborator's work in the personal work space was completed.

As discussed herein, the logic, commands, or instructions that implement aspects of the methods described herein may be provided in a computing system including any number of form factors for the computing system such as desktop or notebook personal computers, mobile devices such as tablets, netbooks, and smartphones, client terminals and server-hosted machine instances, and the like. Another embodiment discussed herein includes the incorporation of the techniques discussed herein into other forms, including into other forms of programmed logic, hardware configurations, or specialized components or modules, including an apparatus with respective means to perform the functions of such techniques. The respective algorithms used to implement the functions of such techniques may include a sequence of some or all of the electronic operations described herein, or other aspects depicted in the accompanying drawings and detailed description below. Such systems and computer-readable media including instructions for implementing the methods described herein also constitute sample embodiments.

This summary section is provided to introduce aspects of the inventive subject matter in a simplified form, with further explanation of the inventive subject matter following in the text of the detailed description. This summary section is not intended to identify essential or required features of the claimed subject matter, and the particular combination and order of elements listed this summary section is not intended to provide limitation to the elements of the claimed subject matter. Rather, it will be understood that the following section provides summarized examples of some of the embodiments described in the Detailed Description below.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a block diagram illustrating a conventional solo document editor.

FIG. 2 is a conceptual diagram illustrating a networked document collaboration system.

FIG. 3 is a block diagram of a collaboration system that enables the creation of personal workspaces with intent signaling in a sample embodiment.

FIG. 4 illustrates a document editor and a sequence of command ops for inserting the character string “Hello World” into a document in a sample embodiment.

FIG. 5 is a conceptual diagram illustrating the splitting of a document's transactional log into two or more branches whereby document creation/editing may continue forward in two (or many) different branches of the same document.

FIG. 6 is a flow chart of a method for signaling intent to other collaborators in a document or project space in a sample embodiment.

FIG. 7A illustrates a viewport of a document editor in which an intent signal is provided to the other collaborators indicating that the user is adding more information at the location indicated by a note space in the document.

FIG. 7B illustrates the viewport of FIG. 7A in which the intent signal further indicates when the user started working on the indicated section.

FIG. 7C illustrates the viewport of FIG. 7A in which the intent signal instead indicates that the user is working on the indicated section.

FIG. 8A illustrates a viewport of the document for a user who is working on a private comment in the form of a note card.

FIG. 8B illustrates a viewport of the document with an intent signal inserted into the document along with a revised paragraph indicating that the user has finished working on the revised paragraph.

FIG. 9 illustrates a block diagram of an example of a machine upon which one or more embodiments may be implemented.

### DETAILED DESCRIPTION

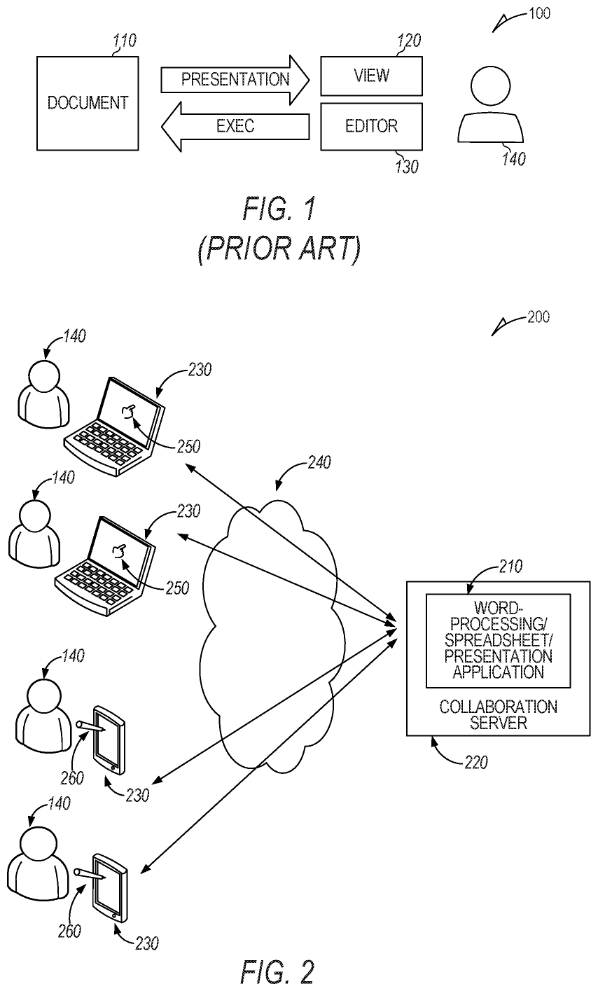

The following description with respect to FIGS. 1-9 sufficiently illustrates specific embodiments to enable those skilled in the art to practice them. Other embodiments may incorporate structural, logical, process, and other changes. Portions and features of some embodiments may be included in, or substituted for, those of other embodiments. Embodiments set forth in the claims encompass all available equivalents of those claims. The example embodiments are presented for illustrative purposes only and are not intended to be restrictive or limiting on the scope of the disclosure or the claims presented herein.

The functions described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware, or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server, or other computer system, turning such computer system into a specifically programmed machine.

It is desired to create a document collaboration system and method that not only provides a personal work space within the document collaboration application but also signals to other collaborators that a particular section of a document is under active revision, the nature of the revision, when the revisions started, whether the revisions are complete, and other indicators of intent by the collaborator(s) working in the personal work space.

The document collaboration system described herein provides a simplified and unified way to signal intent to other collaborators in a document space (e.g., a view or storage containing a document) or project space (e.g., a workspace for a computer aided design drawing) in a document collaboration system. Intent signaling may include whether the reviewing/editing is complete or in progress, the type of work being done (reviewing, authoring, etc.), content that a collaborator is working on, etc. This feature facilitates the effective and efficient collaboration for synchronous and asynchronous collaboration whether the collaborators are together or apart. A collaborator may easily indicate to other collaborators that the portion of the document she is working on is in an early draft state that she prefers that others not view yet to prevent other collaborators from becoming distracted by the ongoing work. The personal work space also provides the collaborator with a sense of privacy and an independent focus area for her work. The work space may be a scratchpad, a window, a dedicated memory space in the collaboration editor, and the like. The personal work space that is out of the main document work area can substitute for opening other documents or applications for this workspace. Collaborators may work in this personal work space, maintain context, write/update status, and fold the changes back into the document seamlessly.

As an example, a user of a collaboration system in a sample embodiment may open a document, navigate to a selected portion of the document to be modified, and create a personal work space for working on the selected portion of the document. Others may be able to see the personal work space, or the personal work space may be closed from view to others. This allows the user to think and work privately. However, the user may invite other collaborators to view the personal work space by granting viewing and/or editing permissions to other collaborators. In sample embodiments, the user also provides messages signaling the intent of her modifications to other collaborators so that the user's actions remain transparent to other collaborators even if the changes to the document are not being shared. For example, the user may draft a note in a note space that signals the user's intent in modifying the selected document section. The note space is provided in the document viewport as a location for displaying text from the collaborator signaling intent of the collaborator in modifying the document or project in the personal work space. This note is displayed to all viewers but only those viewers with proper credentials are permitted to view and/or edit the selected section in the user's personal work space. This feature enables the user to decide whether or not to disclose in-process revisions to other collaborators and to inform the other collaborators of the nature of the changes being made.

FIG. 1 illustrates a conventional solo document editor 100. As illustrated, a document 110 is presented to a user's screen for display by a viewer 120. Any edits to the document 110 made by the user 140 via keystrokes, mouse, pen, etc. are captured by document editor 130, which modifies the content of the document 110 based on the received inputs for presentation by the viewer 120.

On the other hand, in the case of a collaboration editor, the edits must be captured by a viewport for all collaborators to see. FIG. 2 illustrates a conceptual diagram of a networked document collaboration system 200. In FIG. 2, an application 210 such as a word-processing, a spreadsheet, or a presentation application may be provided on a collaboration server 220 to enable one or more collaborators 140A, 140B, 140C, and 140D to create, view, edit, share, and present documents. The collaborators 140A-140D may execute the application 210 on one or more client devices 230A-230D such as a desktop, a laptop, a smart phone, a tablet, or other similar computing device. Collaborators 140A-140D may collaborate on documents to co-author and annotate shared documents. The documents are shared amongst the collaborators 140A-140D over a communications network 240, such as the Internet to enable collaboration and co-authoring.

In one embodiment, a first collaborator 140A may execute the application 210 on a touch-enabled laptop computer 230A to view, edit, share, and/or present a document prepared by a second collaborator 140B. Upon execution of the application 210, the application 210 may present the document to the first collaborator 140A for ink annotation of a portion of the document using touch inputs such as a finger 250 or a stylus pen 260, gesture inputs, voice recognition, typing, eye-tracking, and the like. Other text-based comments may be inserted into the documents through traditional methods such as on-screen keyboard, pen, and/or mouse inputs. Changes to the document are managed by the application 210 and shared with other collaborators. As will be described in more detail below, embodiments of the system described herein allow, for example, collaborator 140A to create a personal workspace within the document and to signal to other collaborators 140B-140D that a particular section of the document is being modified privately by collaborator 140A, whether the reviewing/editing is complete or in progress, the type of work being done (reviewing, authoring, etc.), content that collaborator 140A is working on, etc.

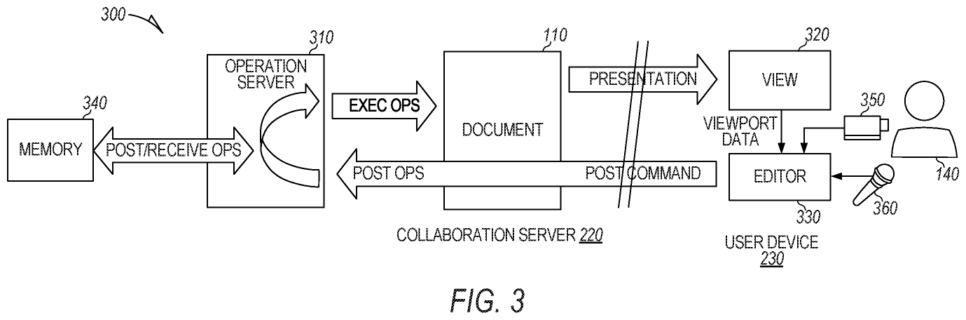

FIG. 3 illustrates a collaboration system 300 that enables the creation of personal workspaces with intent signaling in a sample embodiment. FIG. 3 illustrates a collaboration system 300 that differs in at least four fundamental ways from the solo editor 100 of FIG. 1. First, the viewport presented by viewer 320 is made available to multiple viewers. This functionality is available in several collaboration systems including the Skype® and Teams™ systems available from Microsoft Corporation. Second, the document editor 330 converts collaborator edits into transaction updates to the primitive data structures (a.k.a. “command ops”) making up the document 110. The command ops are posted to an operation server 310 that executes the command ops to change the corresponding primitive data structures of the document 110. Third, the command ops are time stamped and stored in a memory 340 as a record of the transaction updates made to the document 110. Fourth, audio and/or video data from the collaborator 140 optionally may be captured by a microphone 360 and/or a video camera 350 and provided to the memory 340 for storage with the command ops taken during the same time frame. In sample embodiments, the audio/video data may be stored as Binary Large Objects (BLOBs) that are time-synchronized with the command ops provided to the memory 340 by the document editor 330. In sample embodiments, the viewer 320, document editor 330, microphone 360, and video camera are available on the user device 230, while the document 110, memory 340, and operation server 310 are located at the collaboration server 220.

In sample embodiments, the command ops are expressions of a document change from a given frame of reference, typically a primitive data structure. The document 110 is thus defined by a sequence of command ops as the document 110 is created and modified. The command ops modify the existing document state to reflect the change to the document 110 included in each command op. For example, as a document is being created, the steps to create it (insert text here, create a table, populate rows with A, B, C, etc.) may be recorded as respective command ops. The contents of the recording make up the data structure that supports the document editing experience. The contents of the document are stored as a string of command ops in a transactional log.

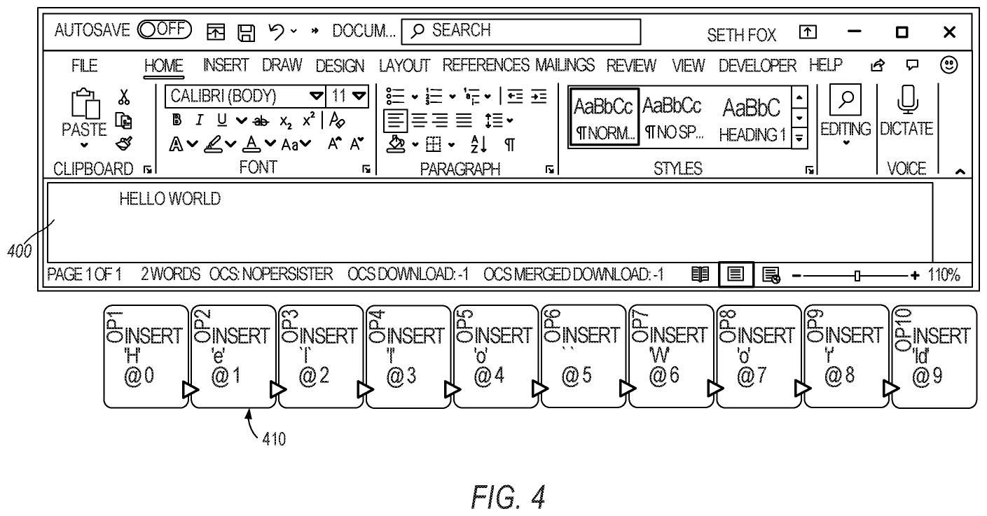

As a simple example of the generation of command ops, FIG. 4 illustrates a document editor 400 into which a user has typed “Hello World.” In this example, “Hello World” is represented as a sequence of command ops 410 for inserting the character string “Hello World” into a document in the document editor 40X). As illustrated, each letter is presented as an “insert” command for inserting a character into a specified location in a character string 410 with the corresponding character(s) in quotations. Similarly, the command may be a command to “create” or “replace” one BLOB object (e.g., an audio recording) with another.

A command op is the atomic unit of change to the primitive data structure. For example, “insert ‘h’ at character position 0 of data stream primary” as the first character of typing “hello” would be the first of 5 command ops, one each for ‘h’, ‘e’, ‘l’, ‘l’, and ‘o’. Every character does not have to be recorded as a separate command op as several characters may be combined. For example, in the example of FIG. 4, the characters ‘l’ and ‘d’ in “world” are combined into one command op “insert ‘ld’ at character position 9 of data stream primary.” It is beneficial for co-authoring in a real-time collaboration to see every such atomic change being made by others if that is the desired user experience. On the other hand, the collaboration system may be modified to present changes at a less granular level if that is the desired user experience.

In sample embodiments, the operation server 310 may include a typescript component that holds the “state” of the document 110. The operation server 310 may further provide a logical view of the document 110 including any primitive data types, collaborative data types, streams, or shared strings of text as described herein. The operation server 310 may also include the logic required to update the state of the document 110 for the receipt of any command op and to translate application state changes into command ops for broadcast.

The primitive data structures in sample embodiments are not limited to characters or strings. In sample embodiments, the audio and/or video data recorded by microphone 360 and/or video recording device 350 may be provided as primitives in the form of binary large objects (“BLOBs”). Transaction updates for the BLOBS are provided to the operation server 350 for execution in the same fashion as the other transaction updates for the string and character data primitives. The transaction updates for the BLOBs are also time stamped and stored in memory 340.

Command ops also may be provided that are designed for collaborative data types. For example, a “map” primitive data type may include a key/value store for a basic or collaborative type. The “map” primitive data type may be associate with a “put” command op. On the other hand, a “stream” primitive data type may include an append-only stream of data that is associated with a “stream” command op. Also, a “sequence” primitive data type may be backed by a merge tree and associated with an insert, remove, or annotate command op.

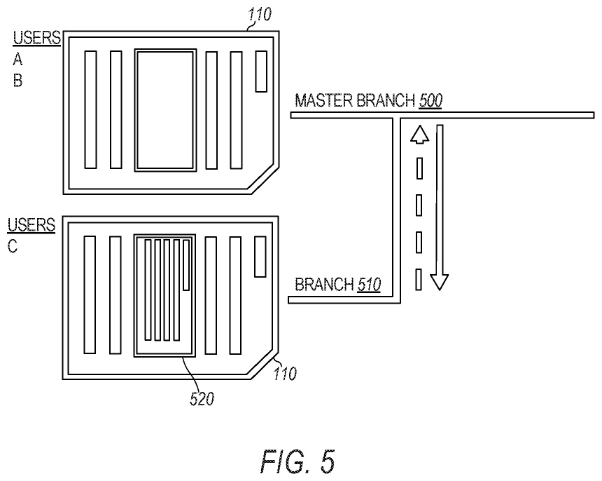

As illustrated in FIG. 5, a document's transactional log of command ops can be split at any time into two or more branches (e.g., master branch 500 and branch 510) so that the document creation/editing may continue forward in two (or many) different branches of the same document. This behavior is analogous to a “Save As” function in Microsoft's WORD—a copy is made and then further changes are made separately in each copy of the document 110. A branch 510 is a bit closer as the changes are stored in the same document as illustrated at 520, but as two different parallel operational logs. As a result, features like reintegrating parts of one of the branches into the first one may be accomplished. This facilitates recombining a personal workspace created as a branch seamlessly back into the original document. As an example, personal notes in a branch of the document may be saved back into the main document. In another embodiment, a collaborator may make a branch of a document that only the collaborator sees. This branch is used for the collaborator's personal workspace. The collaborator may render/experience the document based on the sum of both of the branches by constantly reintegrating the original document changes into the personal branch. In this way, the collaborator may take notes that no one sees while enabling all the changes from the original branch to continue to pour into both the original and into the collaborator's private copy of the document, assuming that the changes made by other collaborators do not conflict with the changes the collaborator made in her private branch.

Within a branch, the document may include an interpretation of the stream of command ops as well as a root map. Maps may be nested in sample embodiments to allow for arbitrarily complex hierarchies. An intelligence map as well as a content map off the root may be determined to maintain the document hierarchy within the respective branches.

The branching of the document as described herein can support a few different user experiences. For example, a user may see a static version of the document, and the user's changes are not shared. On the other hand, a user may see real-time changes from others, but the user's changes are not shared. As another example, a user may see real-time changes from others, while others see a hint of content being added (with description of semantic action “editing”/“writing”) without being able to see the content. These and other variations will be apparent to those skilled in the art.

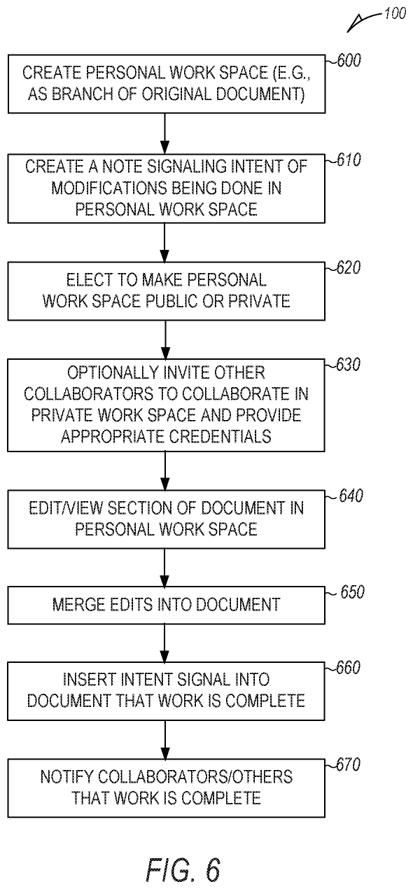

In sample embodiments, a user of the collaboration system 300 may open a document 110, navigate to a selected portion of the document 110 to be modified, and add a personal work space for working on the selected portion of the document 110. FIG. 6 illustrates a sample embodiment of a method for signaling intent of the user's work in the personal work space to other collaborators. For example, as illustrated in FIG. 6, the user may create a personal work space at 600 as a branch of the original document 110 (FIG. 5). The personal work space is typically outside of the main document area and can substitute for opening other documents or applications for the work space. However, the personal work space may also be provided in-line of the original document or in a separate window. By keeping the work space within the document, users can work at a location that maintains context and enables the user to seamlessly fold the revised section back into the document 110.

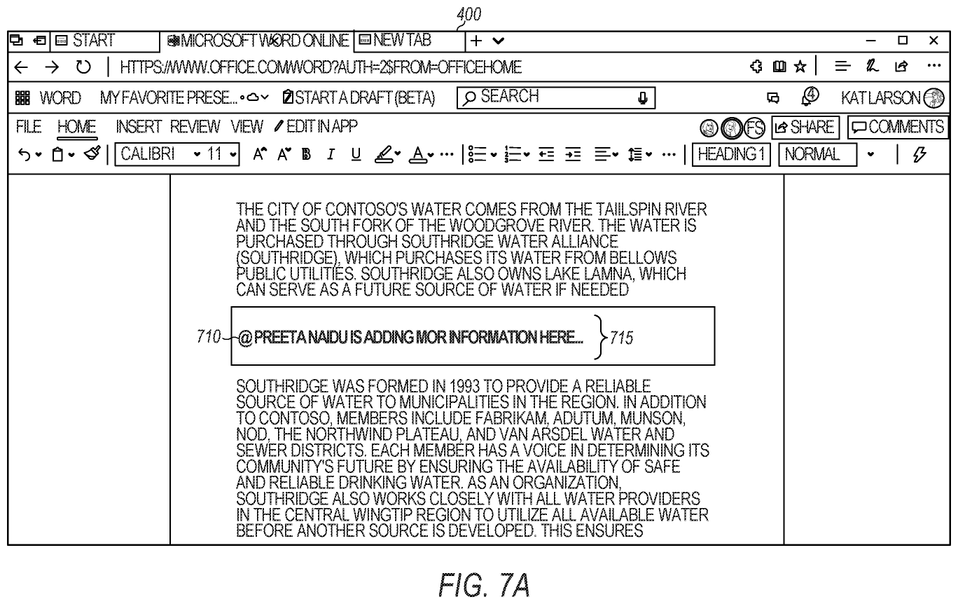

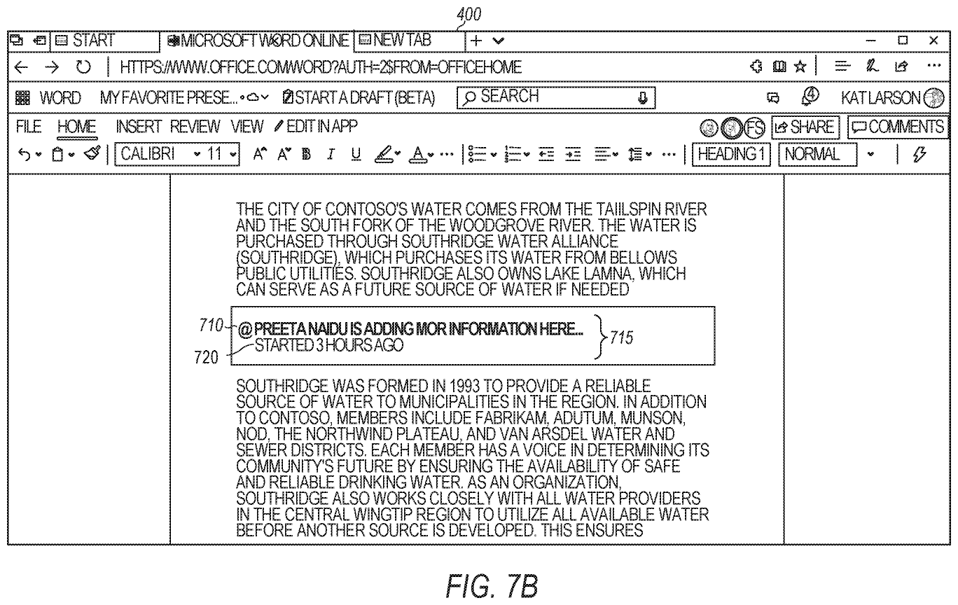

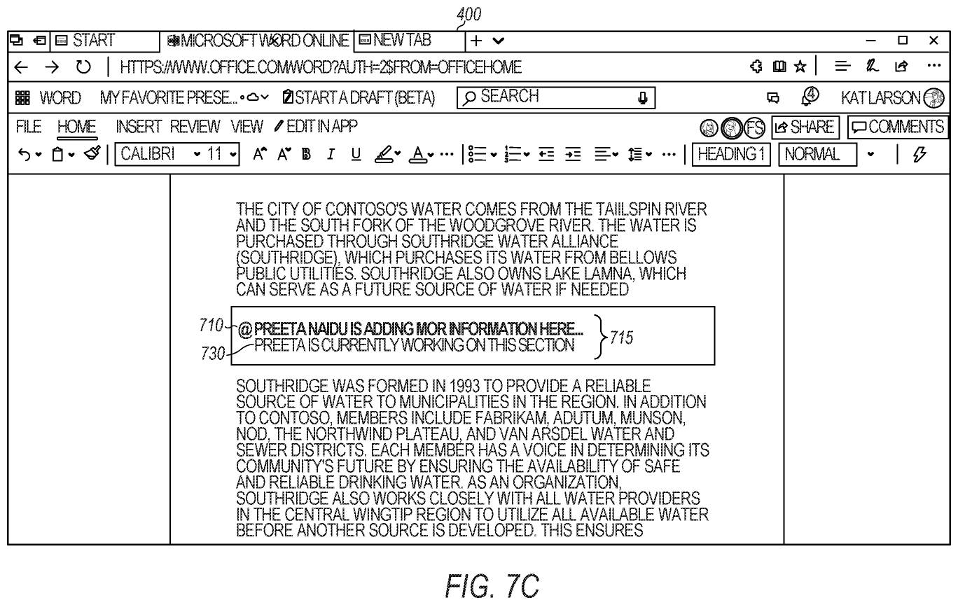

The user then creates a note at 610 that is displayed to all other collaborators to signal the user's intent in making the modifications. The note is associated with the portion of the document 110 being modified by, for example, highlighting the text being modified. The content of the note is provided by the user as text indicating, for example, that the user is adding more information at a specific location in the document 110. This may be illustrated to other collaborators within the document as shown in FIG. 7A. In FIG. 7A, an intent signal 710 is provided to the other collaborators indicating that the user (Preeta Naidu) is adding more information at the location indicated by the note space 715 in the document 110. As indicated in FIG. 7B, the intent signal 710 may further indicate when the user started working on the indicated section as indicated at 720. As indicated in FIG. 7C, the intent signal 710 may instead (or in addition) simply indicate that the user is working on the indicated section as indicated at 730. The user may also provide in-process updates to the intent signal 710 as desired. It will also be appreciated that the note space 715 need not be in-line in the document 110 but may be provided in a comment section of the document as a comment.

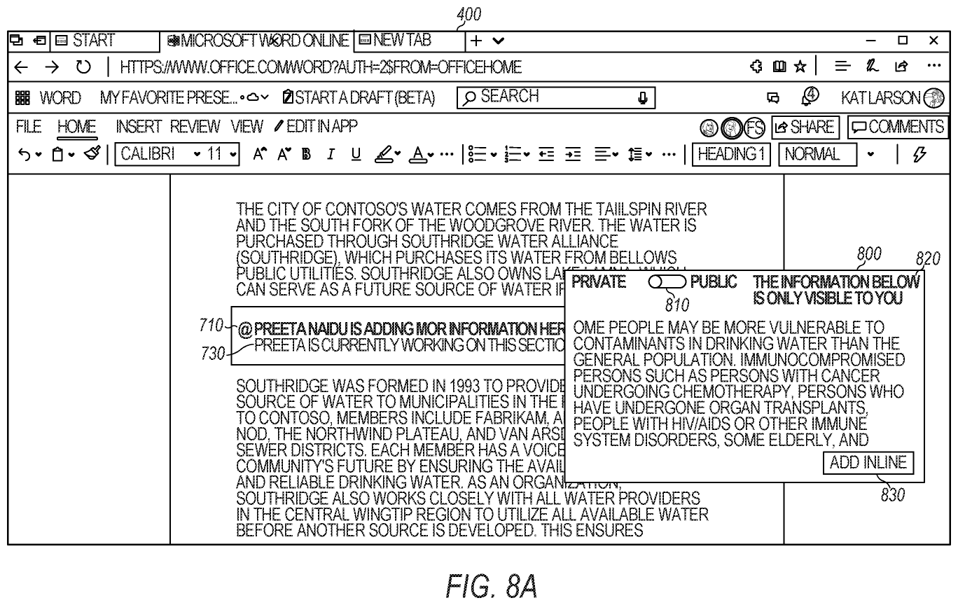

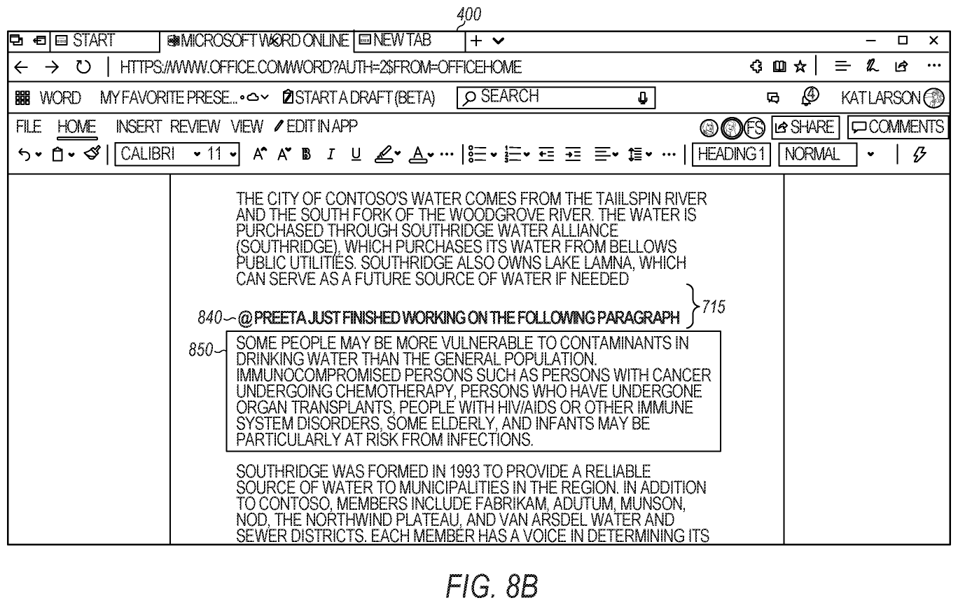

In the method of FIG. 6, the user may next elect at 620 whether to make the personal workspace public or private. For example, FIG. 8A provides a view of the document 110 for a user who is working on a private comment in a personal work space in the form of a note card 800. As illustrated in FIG. 8A, the note card 800 may include a private/public toggle 810 that enables the user to select whether the note card 800 is to be displayed to other collaborators (public) or limited to only the user and optionally other specified collaborators (private). In the private mode, the user may be notified by a message 820 that the information in the note card 800 is only visible to the user. An icon such as an eyeball may be used to indicate that the user is in public mode.

In sample embodiments of the method of FIG. 6, the user may invite one or more of the other collaborators to collaborate in the user's personal workspace at 630. Bringing other collaborators into the personal work space allows the other collaborators to catch-up on the context for modifications quickly and to more readily understand what aspects of the document may require further review. The invitations may be sent via email or via communications within the collaboration system 300. Sample communications mechanisms are described in U.S. Pat. No. 9,715,476 by way of example. However, in sample embodiments, such invitations may further include credentials provided by the user that enable the recipients to have view only or view/edit access to the user's personal workspace in the form of note card 800 in the embodiment illustrated in FIG. 8A. The user may invite other collaborators at any time. This feature enables the user to decide whether or not to disclose in-process revisions to other specified collaborators and to inform the other specified collaborators of the nature of the changes being made before the modifications are complete.

Once the user and other invited collaborators complete the edits at 640 on the portion of the document being edited in the personal workspace in the note card 800, the edited document section is seamlessly merged back into the main document 110 at 650 by, for example, selecting “add inline” button 830 (FIG. 8A). For example, the document branches (FIG. 5) may be resolved by merging the transactional logs for the respective branches. Another intent signal may be inserted into the document 110 at 660 to indicate in the document 110 that the modification of the indicated section by the user has been completed. For example, as illustrated in FIG. 8B, intent signal 840 may be inserted into the document 110 along with the revised paragraph 850 to indicate that the user has finished working on the paragraph 850. In the example of FIG. 8B, the intent signal 840 indicates that the user (Preeta Naidu) has finished working on the highlighted paragraph 850. It will be appreciated that the revised portion of the document 110 need not be a paragraph but may be any chunk of content of the document 110.

Optionally, the method of FIG. 6 may further include the collaboration server sending a message to other collaborators at 670 when the user inserts the revised paragraph 850 into the document 110. In other words, the collaboration system 300 may notify other collaborators when the review/editing of the paragraph 850 has been completed by the user and any invited collaborators. The notification to other collaborators may be in an automatically generated email, a popup in the document view pane of the collaboration system 300, or via a notification user interface within the collaboration system 300 (e.g., of the type described in U.S. Pat. No. 9,715,476). The notification may include a copy of the modified text or a hyperlink to the modified text as desired. On the other hand, the notification sent at 670 need not be sent to all collaborators but may be sent to only those collaborators who have expressed an interest in that section by reviewing or editing that section of the document at any time during the collaboration. User interaction with content may be tracked in document management systems such as Office) available from Microsoft Corporation.

In other embodiments, the collaboration system 300 may detect relationship metrics between the user and other collaborators (or persons outside of the collaboration) who may have expressed an interest in the modified paragraph 850 of the document 110 and send notification to such persons at 670. Systems such as Delve® available from Microsoft Corporation may be used to track relationship metrics among users (e.g., determining coworkers of the user using Outlook® data).

In still other embodiments, the personal work space may be in an encrypted file. The user may provide private keys and credentials to other collaborators to enable the other collaborators to decrypt the portion of the document being edited in the personal work space. If the encrypted file is in another document, a flag or a link may be provided to the encrypted file in the original document 110. Similarly, intelligent branching may be used to branch off a portion of a document 110 that requires specified credentials or permissions for access.

The document collaboration system 300 described herein may also include other features to facilitate collaboration. For example, the relationship of each user to the content may be maintained whereby a user may hover/click on a section of a document to see who has edited that section and provide a hyperlink to the original or other related documents. The user may also view changes to a document section over time by an individual collaborator, chronologically by all collaborators, etc. The changes may be highlighted so that collaborators who missed a real-time collaboration may see highlights of the changes at a later time to be able to catch up more quickly with the changes.

In summary, the document collaboration application described herein provides a simplified and unified way to signal intent to other collaborators in a document or project space in a document collaboration system. The intent signaling may include whether the reviewing/editing is complete or in progress, the type of work being done (reviewing, authoring, etc.), content that a collaborator is working on, etc. This feature facilitates the effective and efficient collaboration for synchronous and asynchronous collaboration whether the collaborators are together or apart. A personal work space is provided that is out of the main document work area that can substitute for opening other documents or applications. Collaborators may work in this personal work space, maintain context, write/update status, and fold the changes back into the document seamlessly.

### System Configuration

Techniques described herein may be used with one or more of the computer systems described herein and/or with one or more other systems. For example, the various procedures described herein may be implemented with hardware or software, or a combination of both. For example, the processor, memory, storage, output device(s), input device(s), and/or communication connections discussed below can each be at least a portion of one or more hardware components. Dedicated hardware logic components can be constructed to implement at least a portion of one or more of the techniques described herein. For example, and without limitation, such hardware logic components may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

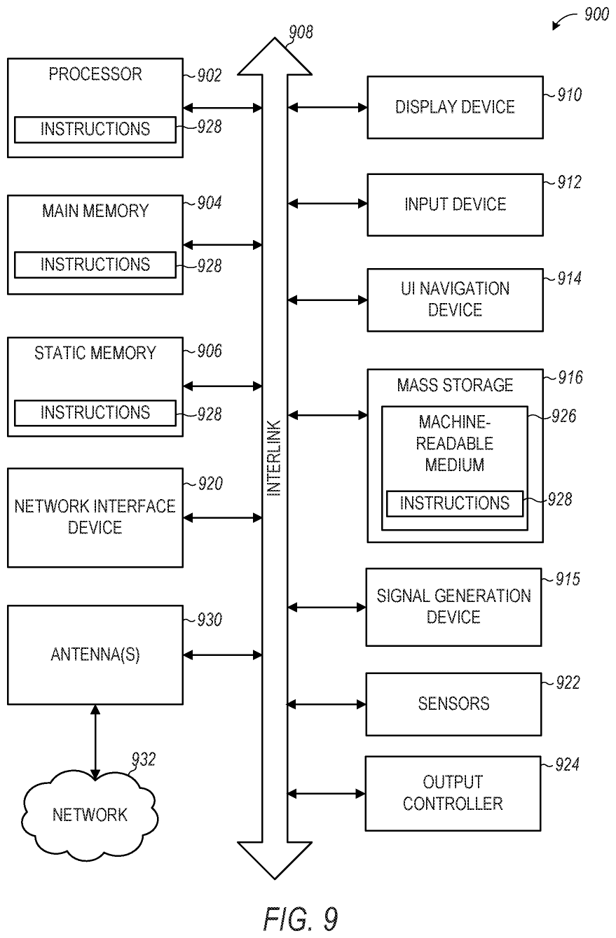

FIG. 9 illustrates a block diagram of an example of a machine 900 upon which one or more embodiments may be implemented. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. In sample embodiments, the machine 900 may be used in embodiments of the collaboration server 220 as well as the user devices 230 (FIG. 2) and may be a personal computer (PC), a tablet PC, a set-top box (STB), a personal digital assistant (PDA), a mobile telephone, a smart phone, a web appliance, a server, a network router, switch or bridge, or any machine capable of executing instructions (sequential or otherwise) that specify actions to be taken by that machine. For example, machine 900 may serve as a workstation, a front-end server, or a back-end server of a communication system. Machine 900 may implement the methods described herein (e.g., FIG. 6) by running software that includes instructions that, when processed, implement the methods described herein. Further, while only a single machine 900 is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, processors, logic, or a number of components, modules, or mechanisms (herein “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. The software, when executed by the underlying hardware of the module, causes the hardware to perform the specified operations.

Accordingly, the term “module” is understood to encompass a tangible hardware and/or software entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a display unit 910 (shown as a video display), an alphanumeric input device 912 (e.g., a keyboard), and a user interface (UI) navigation device 914 (e.g., a mouse or pen). In an example, the display unit 910, input device 912 and UI navigation device 914 may be a touch screen display. In sample embodiments of the machine 900, the input device 912 may include the microphone 360 and/or the video recorder 350. The machine 900 may additionally include a mass storage device (e.g., drive unit) 916, a signal generation device 918 (e.g., a speaker), a network interface device 920, and one or more sensors 922. Example sensors 922 include one or more of a global positioning system (GPS) sensor, compass, accelerometer, temperature, light, camera, video camera, sensors of physical states or positions, pressure sensors, fingerprint sensors, retina scanners, or other sensors. The machine 900 may include an output controller 924, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The mass storage device 916 may include a machine readable medium 926 on which is stored one or more sets of data structures or instructions 928 (e.g., software) embodying or utilized by any one or more of the techniques or functions described herein. The instructions 928 may also reside, completely or at least partially, within the main memory 904, within static memory 906, or within the hardware processor 902 during execution thereof by the machine 900. In an example, one or any combination of the hardware processor 902, the main memory 904, the static memory 906, or the mass storage device 916 may constitute machine readable media.

While the machine readable medium 926 is illustrated as a single medium, the term “machine readable medium” may include a single medium or multiple media (e.g., a centralized or distributed database, and/or associated caches and servers) configured to store the one or more instructions 928. The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 928 may further be transmitted or received over communications network 932 using a transmission medium via the network interface device 920. The machine 900 may communicate with one or more other machines utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 920 may include one or more physical jacks (e.g., Ethernet, coaxial, or phone jacks) or one or more antennas 930 to connect to the communications network 932. In an example, the network interface device 920 may include a plurality of antennas 930 to wirelessly communicate using at least one of single-input multiple-output (SIMO), multiple-input multiple-output (MIMO), or multiple-input single-output (MISO) techniques. In some examples, the network interface device 920 may wirelessly communicate using Multiple User MIMO techniques.

Certain embodiments are described herein as numbered examples 1, 2, 3, etc. These numbered examples are provided as examples only and do not limit the subject technology.

Example 1 is a computer-implemented method of signaling intent to other collaborators in a document or project space comprising creating a personal work space within the document or project space for a collaborator, the personal work space including a note space for the collaborator to add text signaling intent of the collaborator in modifying the document or project in the personal work space, and enabling the collaborator to modify the viewability of the personal work space to permit the personal work space to be viewed by all collaborators, no collaborators, or one or more specified collaborators.

Example 2 is a method as in Example 1, wherein the personal work space relates to a chunk of content within the document or project space and wherein the collaborator is enabled to modify the viewability of the chunk of content by other collaborators during modification of the chunk of content in the personal work space by the collaborator.

Example 3 is a method as in any preceding Example, further comprising enabling the collaborator to assign permissions to the chunk of content for controlling the ability of other collaborators to access the personal work space to view or edit the chunk of content according to the permissions of the other collaborators.

Example 4 is a method as in any preceding Example, wherein the personal work space is in a view pane within the document or project space.

Example 5 is a method as in any preceding Example, wherein the personal work space is formed as a branch of the document.

Example 6 is a method as in any preceding Example, further comprising including in the note space an indication of a time when the collaborator started work in the personal work space.

Example 7 is a method as in any preceding Example, further comprising including in the note space an indication that the collaborator is actively working in the personal work space or that the collaborator has completed work in the personal work space.

Example 8 is a method as in any preceding Example, further comprising sending a notification to other collaborators indicating that the collaborator's modifications in the document or project space have been completed.

Example 9 is a method as in any preceding Example, further comprising determining which other collaborators are to receive the notification by tracking which collaborators have interacted with a portion of the document or project space that has been modified by the collaborator.

Example 10 is a method as in any preceding Example, wherein the notification includes an indication of a time when the collaborator's work in the personal work space was completed.

Example 11 is a collaboration system that signals intent to other collaborators in a document, comprising a memory that stores a document for collaboration, and a collaboration server having one or more processors and a memory including instructions that when executed by the one or more processors cause the one or more processors to perform a method including creating a personal work space within the document for a collaborator, the personal work space including a note space for the collaborator to add text signaling intent of the collaborator in modifying the document in the personal work space, and enabling the collaborator to modify the viewability of the personal work space to permit the personal work space to be viewed by all collaborators, no collaborators, or one or more specified collaborators.

Example 12 is a collaboration system as in Example 1, wherein the personal work space relates to a chunk of content within the document and wherein the one or more processors executed instructions that enable the collaborator to modify the viewability of the chunk of content by other collaborators during modification of the chunk of content in the personal work space by the collaborator.

Example 13 is a collaboration system as in Example 11 or 12, further comprising instructions that when executed by the one or more processors enable the collaborator to assign permissions to the chunk of content for controlling the ability of other collaborators to access the personal work space to view or edit the chunk of content according to the permissions of the other collaborators.

Example 14 is a collaboration system as in Examples 11-13, further comprising a view pane including the personal work space within the document.

Example 15 is a collaboration system as in Examples 11-14, wherein the document is stored in the memory as a string of primitive data structures and update transactions to the primitive data structures and the personal work space is formed as a branch of the document.

Example 16 is a collaboration system as in Examples 11-15, wherein the note space includes an indication of a time when the collaborator started work in the personal work space.

Example 17 is a collaboration system as in Examples 11-16, wherein the note space includes an indication that the collaborator is actively working in the personal work space or that the collaborator has completed work in the personal work space.

Example 18 is a collaboration system as in Examples 11-17, further comprising instructions that when executed by the one or more processors enable sending a notification to other collaborators indicating that the collaborator's modifications in the document have been completed.

Example 19 is a collaboration system as in Examples 11-18, further comprising instructions that when executed by the one or more processors enable determining which other collaborators are to receive the notification by tracking which collaborators have interacted with a portion of the document that has been modified by the collaborator.

Example 20 is a collaboration system as in Examples 11-19, wherein the notification includes an indication of a time when the collaborator's work in the personal work space was completed.

Alternative implementations of the system for signaling intent to other collaborators in a document or project space as described herein are contemplated. For example, the system for signaling intent to other collaborators in a document or project space as described herein may be implemented within or in association with several products and services besides a collaboration server. Such additional products and services include, for example, editing tools within word processing applications, presentation applications, enterprise management applications, messaging applications, spreadsheet applications, database applications, contacts applications, gaming applications, e-commerce applications, e-business applications, transaction applications, web interface applications, exchange applications, calendaring applications, chat applications, and the like. Thus, the system for signaling intent to other collaborators in a document or project space as described herein is not to be limited to the system described in specific examples. These and other implementations are included within the context of the disclosed embodiments as set forth in the following claims.

In the above Detailed Description, various features may be grouped together to streamline the disclosure. However, the claims may not set forth every feature disclosed herein as embodiments may feature a subset of the features. Further, embodiments may include fewer features than those disclosed in a particular example. Also, although the subject matter has been described in language specific to structural features and/or methodological acts, it is to be understood that the subject matter defined in the appended claims is not necessarily limited to the specific embodiments, features, or acts described above. Rather, the specific embodiments, features, and acts described above are disclosed as example forms of implementing the claims. Thus, the following claims are hereby incorporated into the Detailed Description, with a claim standing on its own as a separate embodiment.

What is claimed is:

1. A method of signaling intent to other collaborators in a document or project space, comprising:
creating a personal work space within the document or project space for a collaborator, the personal work space including a note space for the collaborator to add text signaling intent of the collaborator in modifying the document or project in the personal work space; and
enabling the collaborator to modify the viewability of the personal work space to permit the personal work space to be viewed by all collaborators, no collaborators, or one or more specified collaborators.

2. A method as in claim 1, wherein the personal work space relates to a chunk of content within the document or project space and wherein the collaborator is enabled to modify the viewability of the chunk of content by other collaborators during modification of the chunk of content in the personal work space by the collaborator.

3. A method as in claim 2, further comprising enabling the collaborator to assign permissions to the chunk of content for controlling the ability of other collaborators to access the personal work space to view or edit the chunk of content according to the permissions of the other collaborators.

4. A method as in claim 1, wherein the personal work space is in a view pane within the document or project space.

5. A method as in claim 1, wherein the personal work space is formed as a branch of the document.

6. A method as in claim 1, further comprising including in the note space an indication of a time when the collaborator started work in the personal work space.

7. A method as in claim 1, further comprising including in the note space an indication that the collaborator is actively working in the personal work space or that the collaborator has completed work in the personal work space.

8. A method as in claim 1, further comprising sending a notification to other collaborators indicating that the collaborator's modifications in the document or project space have been completed.

9. A method as in claim 8, further comprising determining which other collaborators are to receive the notification by tracking which collaborators have interacted with a portion of the document or project space that has been modified by the collaborator.

10. A method as in claim 8, wherein the notification includes an indication of a time when the collaborator's work in the personal work space was completed.

11. A collaboration system that signals intent to other collaborators in a document, comprising:
a memory that stores a document for collaboration; and
a collaboration server having one or more processors and a memory including instructions that when executed by the one or more processors cause the one or more processors to perform a method including:
creating a personal work space within the document for a collaborator, the personal work space including a note space for the collaborator to add text signaling intent of the collaborator in modifying the document in the personal work space; and
enabling the collaborator to modify the viewability of the personal work space to permit the personal work space to be viewed by all collaborators, no collaborators, or one or more specified collaborators.

12. A collaboration system as in claim 1, wherein the personal work space relates to a chunk of content within the document and wherein the one or more processors executed instructions that enable the collaborator to modify the viewability of the chunk of content by other collaborators during modification of the chunk of content in the personal work space by the collaborator.

13. A collaboration system as in claim 12, further comprising instructions that when executed by the one or more processors enable the collaborator to assign permissions to the chunk of content for controlling the ability of other collaborators to access the personal work space to view or edit the chunk of content according to the permissions of the other collaborators.

14. A collaboration system as in claim 11, further comprising a view pane including the personal work space within the document.

15. A collaboration system as in claim 11, wherein the document is stored in the memory as a string of primitive data structures and update transactions to the primitive data structures and the personal work space is formed as a branch of the document.

16. A collaboration system as in claim 11, wherein the note space includes an indication of a time when the collaborator started work in the personal work space.

17. A collaboration system as in claim 11, wherein the note space includes an indication that the collaborator is actively working in the personal work space or that the collaborator has completed work in the personal work space.

18. A collaboration system as in claim 11, further comprising instructions that when executed by the one or more processors enable sending a notification to other collaborators indicating that the collaborator's modifications in the document have been completed.

19. A collaboration system as in claim 18, further comprising instructions that when executed by the one or more processors enable determining which other collaborators are to receive the notification by tracking which collaborators have interacted with a portion of the document that has been modified by the collaborator.

20. A collaboration system as in claim 18, wherein the notification includes an indication of a time when the collaborator's work in the personal work space was completed.
